(19) United States
(12) Patent Application Publication
(10) Pub. No.: US 2024/0378338 A1
(43) Pub. Date: Nov. 14, 2024

(54) ACTOR GRAPH ENGINE

(71) Applicant: Corezoid, Inc., Wilmington, DE (US)

(72) Inventor: Oleksandr Vityaz, Dnipropetrovsk (UA)

(21) Appl. No.: 18/313,477

(22) Filed: May 8, 2023

(51) Int. Cl. G06F 30/20

(52) U.S. Cl. CPC G06F 30/20; G06F 2111/02; G06F 2111/10

(57) ABSTRACT

An engine for an actor graph-based model generation and processing. The engine includes a processor; memory with machine-readable instructions that when executed by the processor, cause the processor to: acquire object-related data of an object to be modeled, generate a plurality of modeling parameters based on the object-related data, convert the plurality of model parameters into an actor graph mathematical object representing the original object and generate a model comprising the created actor graph, receive from a user node a simulation request comprising a status request or at least one new modeling parameter or graph structure change request, parse the simulation request to derive the at least one new modeling parameter, input the at least one new modeling parameter into the model; and receive at least one simulated output from the model comprising a new value of an endogenous parameter.

### FIELD OF DISCLOSURE

The present disclosure generally relates to object modeling, and more particularly, to an automated engine for generation and processing of actor graph mathematical objects.

### BACKGROUND

Object and process simulation systems are conventionally implemented based on mathematical models built based on various types of object-related data.

A model is a representation of reality such as an object or a process. A conventional model is a simplification or abstraction. A mathematical model differs from the more tangible physical model, in that “reality” is represented by an equation or series of equations. There are many kinds of models. For example, econometric models have their basis in economic theory, are derived using statistical techniques, and are used in studying relationships among economic variables. Two important elements of equations are variables and parameters. Variables represent the elements of the system being modeled (e.g., the number of cars or trucks in a certain state). In a mathematical model the values of some variables may be specified outside the model. These variables are called exogenous variables or parameters.

The values of other variables are calculated within a model. These variables are referred to as endogenous. Knowing which variables are exogenous and which are endogenous can be important in understanding the results of a model. Parameters of an equation are factors that qualify the variables. For example, one might calculate the number of large-size cars sold in a year as a function of the annual income of car buyers and their tendency to buy large cars. A modeler might create a model in which automobile demand is a function of several variables (e.g., income) and in which fuel consumption is a function of auto demand, plus several other variables (e.g., the fuel economy of the automobiles sold). The specification of the equations and the relationships among the various equations that describe how the variables are linked in the real world represent the overall logic of the model.

An analyst needs to understand the logic of a model in order to use it intelligently. This presents a problem since regular users may not be able to use a model. When constructing models, model builders usually experiment with a wide range of alternative forms to find the closest fit of the equations to the sample data. However, these equations are hard to use and often produce inaccurate results in terms of simulation of an object's behavior and prediction of outcome based on certain input parameters. When used for forecasting or policy analysis, such a mis specified model is poorer than a proper specification that fits less closely to sample data.

Graphs are mathematical objects which contain information on both the components of the described object and the relations between them, including semantic relations which reflect the human knowledge about the object. Graph-based mathematical models provide accurate description of complex structured objects. Both human thinking and comprehension processes as well as human knowledge about real objects follow graph-like patterns to structure facts and their cognitive relationships. The best way to reflect these patterns in a model of a real-world object is to use graph-based structures. Hence, a graph-based model is also the easiest model to understand and use correctly for an analyst and, especially, for a non-professional model user.

Accordingly, a system and method for an actor graph engine for an automated generation and processing of actor graph-based models are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides an engine for an actor graph-based model generation and processing. The system includes a processor of a graph processing node connected to at least one user node over a network; a memory on which are stored machine-readable instructions that when executed by the processor, cause the processor to: acquire object-related data of an object to be modeled; generate a plurality of modeling parameters based on the object-related data; convert the plurality of modeling parameters into an actor graph data structure simulating the object and generate a model of the object comprising a graph; receive a simulation request comprising at least one new modeling parameter comprising a graph status or structure change from the at least one user node; parse the simulation request to derive the at least one new modeling parameter; input at least one new modeling parameter into the model; and receive at least one simulated output from the model comprising a new value of an endogenous parameter.

Another embodiment of the present disclosure provides a method that includes one or more steps of acquiring object-related data of an object to be modeled; generating a plurality of modeling parameters based on the object-related data; converting the plurality of modeling parameters into an actor graph data structure simulating the object and generate a model of the object comprising a graph; receiving a simulation request comprising at least one new modeling parameter comprising a graph status or structure change from the at least one user node; parsing the simulation request to derive the at least one new modeling parameter; inputting the at least one new modeling parameter into the model; and receiving at least one simulated output from the model comprising a new value of an endogenous parameter.

Another embodiment of the present disclosure provides a computer-readable medium including instructions for acquiring object-related data of an object to be modeled; generating a plurality of modeling parameters based on the object-related data; converting the plurality of modeling parameters into an actor graph data structure simulating the object and generate a model of the object comprising a graph; receiving a simulation request comprising at least one new modeling parameter comprising a graph status or structure change from the at least one user node; parsing the simulation request to derive the at least one new modeling parameter; inputting the at least one new modeling parameter into the model; and receiving at least one simulated output from the model comprising a new value of an endogenous parameter.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a network diagram of an automated engine for actor graph-based model generation and processing consistent with the present disclosure;

FIG. 2 illustrates the anatomy of a graph-based model basic element—an actor consistent with the present disclosure;

FIG. 3 illustrates various types of actors used in the actor graph-based model consistent with the present disclosure;

FIG. 4 illustrates a detailed diagram of an event actor in the actor graph-based model consistent with the present disclosure;

FIG. 5 illustrates a diagram of a trigger actor in the actor graph-based model consistent with the present disclosure;

FIG. 6 illustrates a diagram of an account tree in the actor graph-based model consistent with the present disclosure;

FIG. 7 illustrates the process of double entry accounting with account trees in the actor graph-based model consistent with the present disclosure;

FIG. 8 illustrates actor and event lifecycles in the actor graph-based model consistent with the present disclosure;

FIG. 9 illustrates actor status transformations in the actor graph-based model consistent with the present disclosure;

FIG. 10 illustrates actor topology and event convection in the actor graph-based model consistent with the present disclosure;

FIG. 11 illustrates a diagram of horizontal event convection in the actor graph-based model consistent with the present disclosure;

FIG. 12 illustrates actor topology and examples of actor jet change in the actor graph-based model consistent with the present disclosure;

FIG. 13 illustrates a diagram of actor jets and vertical convection of events in the actor graph-based model consistent with the present disclosure;

FIG. 14 illustrates a diagram of convection of events due to actor interaction in the actor graph-based model consistent with the present disclosure;

FIG. 15 illustrates how actor interaction is being reflected on actor accounts in the actor graph-based model consistent with the present disclosure;

FIG. 16 illustrates an edge actor consistent with the present disclosure;

FIG. 17 illustrates how two actors are being connected via an edge actor in the actor graph-based model consistent with the present disclosure;

FIG. 18 illustrates actors' connection rules in the actor graph-based model consistent with the present disclosure;

FIG. 19 illustrates actor edges (null, virtual, real) in the actor graph-based model consistent with the present disclosure;

FIG. 20 illustrates the shape of the “Actor” math object in the actor graph-based model consistent with the present disclosure;

FIG. 21 illustrates an example of an actor graph structure in the actor graph-based model consistent with the present disclosure;

FIG. 22 illustrates examples of different actor graph types in the actor graph-based model consistent with the present disclosure;

FIG. 23 illustrates an example of a 3D actor graph structure in the actor graph-based model consistent with the present disclosure;

FIG. 24 illustrates an example of a 2D layer in the 3D actor graph in the actor graph-based model consistent with the present disclosure;

FIG. 25 illustrates a recursion in actor graphs of an actor graph-based model consistent with the present disclosure;

FIG. 26 illustrates a network diagram of a system for actor graph-based mode automated generation and processing including detailed features of a graph processing node consistent with the present disclosure;

FIG. 27A illustrates a flowchart of a method for actor graph-based model generation and processing consistent with the present disclosure;

FIG. 27B illustrates a further flowchart of a method for actor graph-based model generation and processing consistent with the present disclosure; and

FIG. 28 illustrates a block diagram of a system including a computing device for performing the method of FIGS. 27A and 27B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in, the context of processing job applicants, embodiments of the present disclosure are not limited to use only in this context.

The present disclosure provides a system, method and computer-readable medium for an automated engine for generation and processing of actor graph-based mathematical objects.

In one embodiment of the present disclosure, the system provides a technology for presenting any complex objects (e.g., an enterprise) in a form of mathematical model based on actor graphs. The actor graph disclosed herein has the following features:
commonly used graph nodes (vertices) are replaced with “actors”—i.e., active nodes which embed a function or a process, a set of account trees to store variables and a set of related triggers to check thresholds on accounts and react to events;
commonly used “graph edges” are replaced with “edge actors”—i.e., edges which embed a function or a process; and
addition of “event actors”—i.e., actor nodes representing events.

The actor graph consistent with the disclosed embodiments allows to build models of complex dynamic objects with multiple active nodes and concurrent processes.

The actor graph-based model represents a graph of internal (i.e., endogenous) and external (i.e., exogenous) actors. The properties and interconnections of these actors reflect real behavior of a modeled object in the environment.

In one embodiment, the actor graph-based model may demonstrate a new quality of emergence—i.e., exhibit its own properties and behaviors that stem neither from individual model elements nor from their sum. In other words, the modeled system may have properties that are different from a sum of properties of the individual system components.

In one embodiment, the actor-graph based model may also demonstrate a new quality of recursion—i.e., an actor being an element of an actor graph may incorporate another actor graph as its function. Such an actor is called a “Graph actor”.

In one embodiment, the actor graph-based mathematical model may represent an enterprise by modeling all its objects, processes, structures, dependencies. The properties, interconnections and interaction among these actors may reflect real operation and behavior of the source enterprise.

The model of the source enterprise may allow to monitor the performance of the enterprise, control its activity in real time, validate some hypothesis and assess outcomes of these hypotheses by simulation of different scenarios based on input of various parameters of enterprise operation. This will result in optimization of real-time enterprise management. As discussed above, the input data may be acquired from internal and external sources. In one embodiment, the input data may be either generated in real-time using archived data or obtained in real time by connecting the actual sources of live data to the model (e.g., on-line data, statistical data or dynamically processed data). For example, real-time banking data, customer orders, financial transaction data may be used for forming on-line reported data, management dashboards, etc.

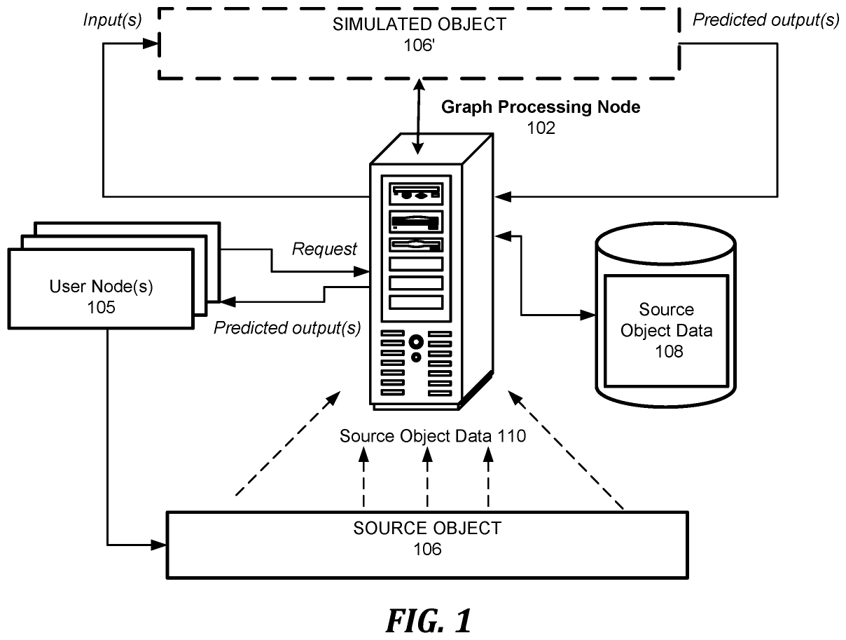

FIG. 1 illustrates a network diagram of an automated engine for generation and processing of actor graph-based mathematical objects.

Referring to FIG. 1, the example network includes a graph processing node 102 connected to a user node(s) 105 over a network. The graph processing node 102 is configured to simulate a mathematical model 106′ of a source object 106 associated with one or more user node 105. As discussed above, the graph processing node 102 may acquire source object-related dynamic data 110 directly from the source object 106 including multiple modeling/simulation parameters. The graph processing node 102 may also acquire source object-related static and historic data 108 uploaded earlier or entered manually and stored in one or more databases that may be implemented as cloud storages.

As discussed above, the graph processing node 102 may generate the simulated object 106′ in the form of an actor graph-based mathematical model based on the source object dynamic data 110 and the source object-related static and historic data 108 used for generation of modeling/simulation parameters. Once the simulated object 106′ is generated, the user node(s) 105 may send to the graph processing node 102 a request for object status data, a model data change request or a request to simulate a particular hypothesis scenario, using the simulated object 106′ based on input parameters included in the request. Then, the graph processing node 102 may implement the requested actions or simulate the requested hypothesis scenario based on the input parameters and may receive a requested output(s) from the simulated object 106′ (i.e., the graph-based mathematical model) and may process and provide these outputs to the requester user node 105.

While this example describes in detail only one graph processing node 102, multiple such nodes may be connected to the network of user nodes. It should be understood that the graph processing node 102 may include additional components and that some of the components described herein may be removed and/or modified without departing from a scope of the graph processing node 102 disclosed herein. The graph processing node 102 may be a computing device or a server computer, a cloud server, or the like. As discussed above, the modeling data may be acquired from internal (e.g., 110) and external sources (e.g., 108). In one embodiment, the input data may be generated in real-time using archived data or obtained real-time from the object and its live data sources (e.g., on-line data, customer orders, production and sales data, statistical data or dynamically processed data).

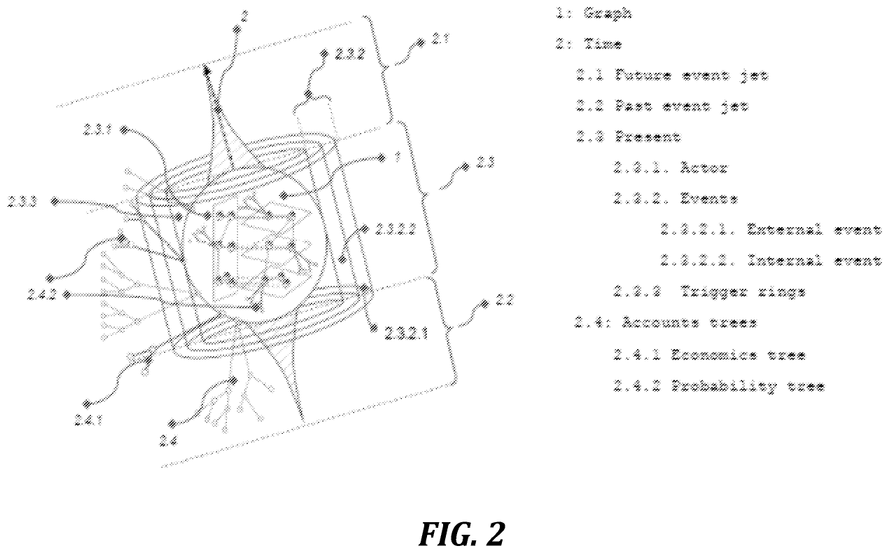

FIG. 2 illustrates anatomy of a graph-based model basic element—an actor consistent with the present disclosure. Actor represents an active or passive component (entity) of the modeled object. Actor may execute an actor function, which may be a null function, or a process to be executed by an actor when trigger conditions are met. Actor may include another actor, or another actor graph, nested in a recursive manner. In FIG. 2, the actor includes the following elements:
2.1 Future event jet—expected flow of future events
2.2 Past event jet—actual flow of events in the past
2.3 Present—events processed currently
2.3.1. Actor function—a function (including a null function) or a process to be executed by the actor when trigger conditions are met, or another actor, or another actor graph
2.3.2. Events
2.3.2.1. Event external
2.3.2.2. Event internal
2.3.3 Trigger ring—a set of trigger conditions that allows the event (external or internal) to activate the actor function if the trigger conditions of the ring are met
2.4: Accounts trees—tree-shaped data structures used as accounts to store and update variable parameters of the actor
2.4.1 Economics tree—account tree storing economic variables
2.4.2 Probability tree—account tree storing event probability variables.

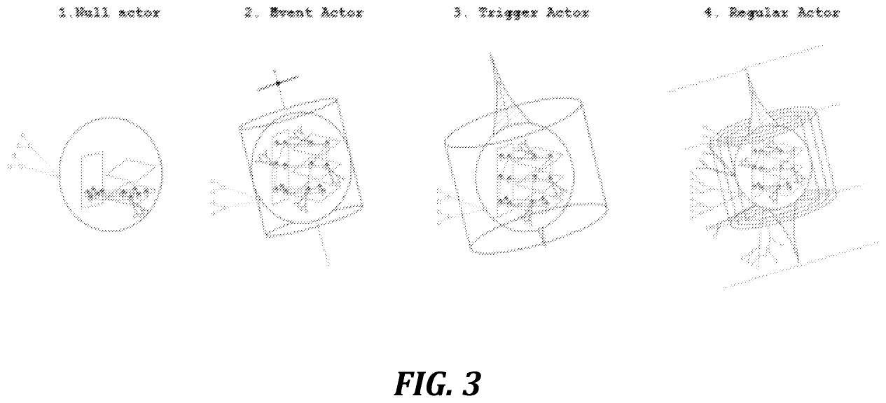

FIG. 3 illustrates various types of actors (actor states) used in the actor graph-based model consistent with the present disclosure. An actor can be configured to act as one of 4 actor types: Null actor 301, Event actor 302, Trigger actor 303, Regular actor 304. Graph actor is a variant of a Regular actor, which includes another graph as its function.

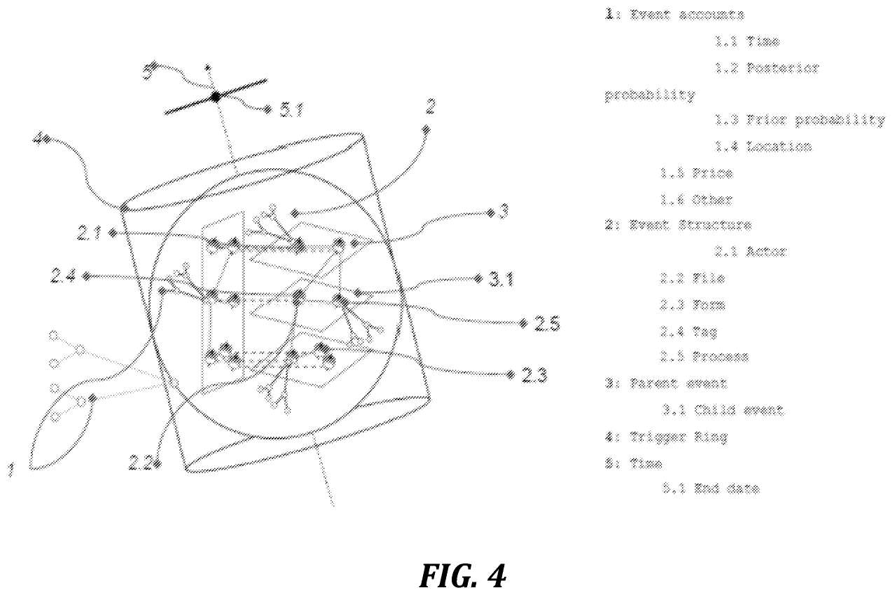

FIG. 4 illustrates a detailed diagram of an event actor in the actor graph-based model consistent with the present disclosure. The event actor may represent an external or internal event in the graph-based model. It includes the following elements storing the event-related data:
1: Event's account
1.1 Time—the expected end time of the event
1.2 Posterior probability—calculated posterior probability of the event
1.3 Prior probability—calculated prior probability of the event
1.4 Location—event location
1.5 Price—loss or gain associated with the event
1.6 Other
2: Event Structure
2.1 Actor
2.2 File—data file(s) that may be associated with the event
2.3 Form—template file that may be associated with the event
2.4 Tag—tag(s) that may be associated with the event
2.5 Process—a process to be executed if the event trigger is activated
3: Parent event
3.1 Child event—related event actor that may be created (activated) by the event process
4: Trigger ring—a criterium that has to be met for the event to be activated
5: Time—time axis
5.1 End date—the actual end date and time of the event

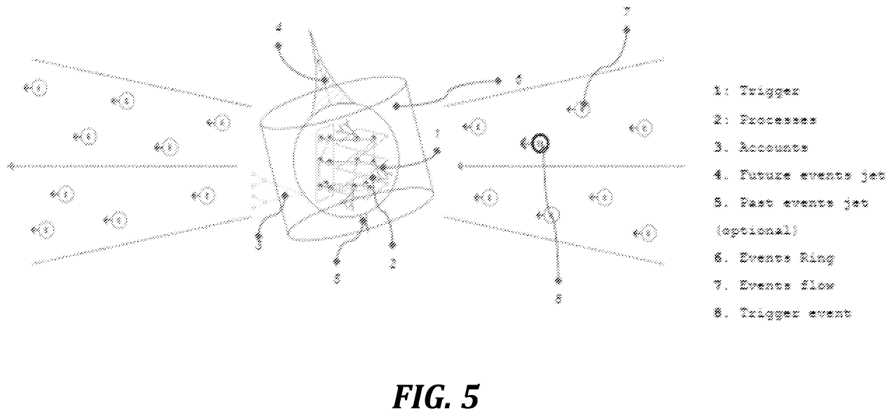

FIG. 5 illustrates a diagram of a trigger actor in the actor graph-based model consistent with the present disclosure. Trigger actor 1 analyzes the incoming events flow 7 and activates the actor process 2 when any event 8 in the flow meets the pre-set trigger conditions of the trigger ring 6. Trigger conditions may be tied to the status of actor accounts 3—certain account value or its deviation.

The trigger actor includes:
1. Trigger
2. Processes
3. Accounts
4. Future events jet
5. Past events jet (optional)
6. Events Ring
7. Events flow
8. Trigger event

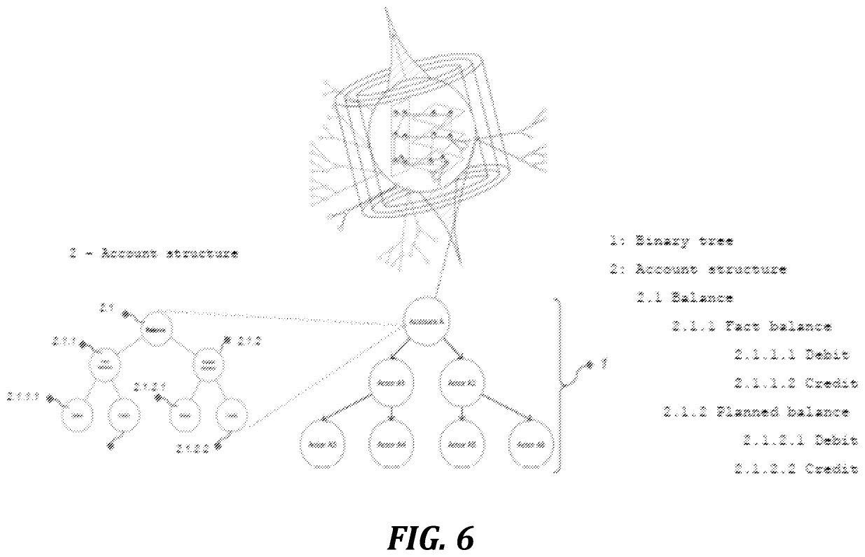

FIG. 6 illustrates a diagram of an actor account tree in the actor graph-based model consistent with the present disclosure. Actor accounts are used to store the values of actor model variables. Each account of an actor has a 3-level binary tree structure, providing an ability to record for each variable the “planned” value and “fact” (actual) value separately, and for each of them—to record “debit” and “credit” changes to a value separately. Account tree structure includes:
1: Binary tree
2: Account structure
2.1 Balance
2.1.1 Fact balance
2.1.1.1 Debit
2.1.1.2 Credit
2.1.2 Planned balance
2.1.2.1 Debit
2.1.2.2 Credit

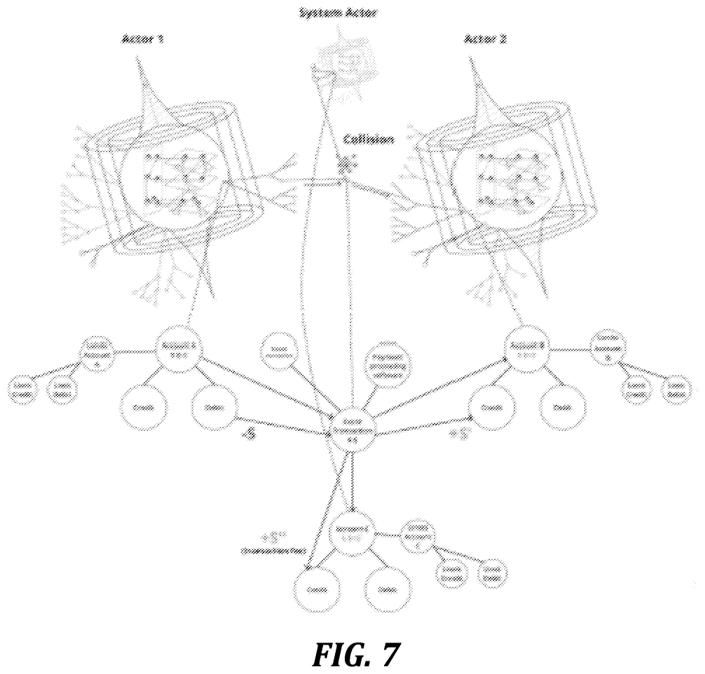

FIG. 7 illustrates the process of double entry accounting with account trees in the actor graph-based model consistent with the present disclosure. When Actor 1 interacts with Actor 2, their collision creates an event, for example—a transaction of fund transfer in the amount of S dollars from Account A of Actor 1 to Account B of Actor 2. A system event actor—“Transaction event”—is being created and the process embedded in this actor records an operation of “−S” dollars on debit actor of Account A. Then it splits the amount S into the transferred amount “+S′”, recorded on the credit actor of Account B, and the transaction fee amount “+S″”, recorded on the credit actor of Account C, which belongs to the service provider. Each of accounts A, B, C has also a pair of trigger actors storing the limit values for debit and credit separately. This allows to build business logic based on account limits (thresholds).

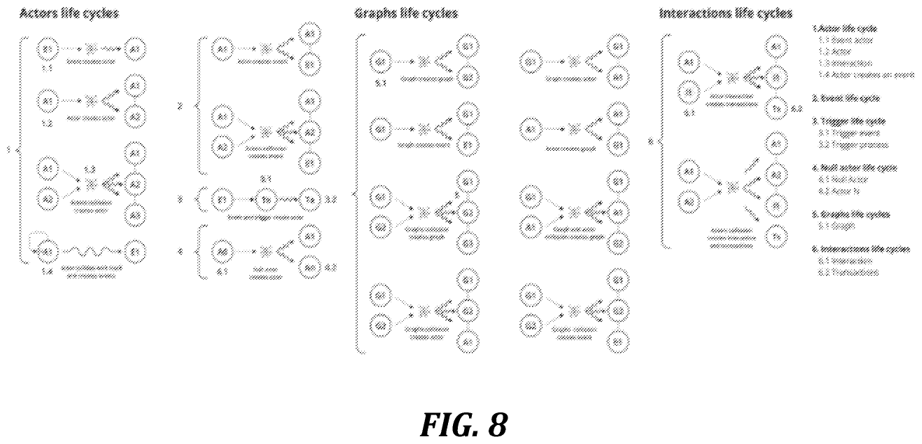

FIG. 8 illustrates a diagram of actor and event lifecycles in the actor graph-based model consistent with the present disclosure. The lifecycle examples include:
1. Actor life cycle—new actor(s) created by an event (1.1), actor (1.2), interaction of two actors (1.3) and an event created by actor (1.4)
2. Event life cycle—new event(s) created by actor process and by collision of two actors
3. Trigger life cycle—an event activates an Event trigger 3.1, which initiates a trigger process 3.2, which in turn creates a trigger actor
4. Null actor life cycle—a null actor 4.1 initiates n processes which create n new actors A1 . . . An (4.2)
5. Graph life cycles:
   graph G1 (5.1) initiates processes which create a new graph G2, a new event E1 or a new actor A1;
   interaction (collision) of two graphs G1 and G2 initiates processes which create a new graph G3, a new actor A1 or a new event E1;
   actor A1 initiates a process which creates a new graph G1;
   collision of a graph G1 and actor A1 initiates a process which creates a new graph G2;
6. Interactions life cycles:
   actor A1 interaction I1 initiates a process which creates a new transaction T1;
   collision of actors A1 and A2 initiates processes which create a new interaction actor I1 and a new transaction Ts.

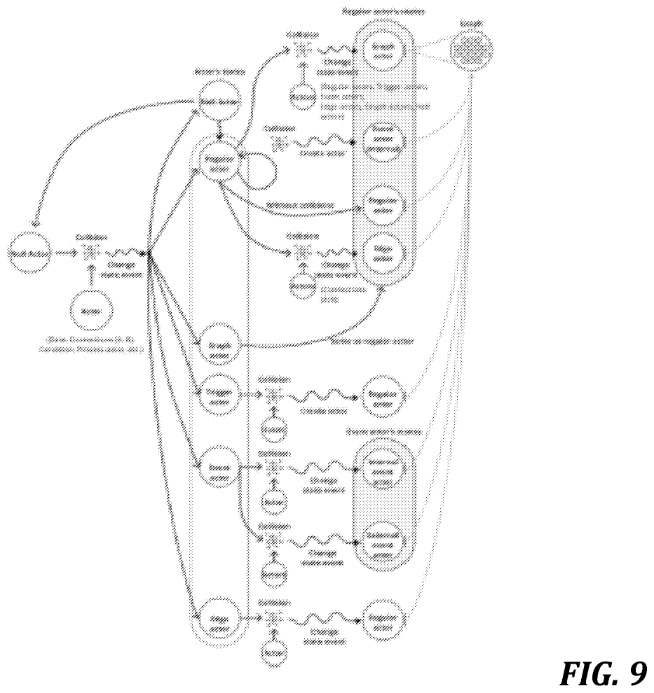

FIG. 9 illustrates examples of possible transformations of actor statuses presented in FIG. 3—i.e., transitions between Null actor, Event actor, Trigger actor and Regular actor statuses. These status transformations may be caused by the events, collisions or processes in this or other actors:
a Null actor subject to a collision with another actor (Date, Connection, condition, Process actor etc.) may create a Change state event and process, which may keep its state unchanged (Null actor) or transform it into Regular actor, Graph Actor, Trigger actor, Event actor or Edge actor state;
a Regular actor without collision remains in the state of a Regular actor. After a collision with another Regular, Trigger, Even, Edge, Graph or Null actor it may initiate a Change state event and process which transforms it into a Graph actor state. Collision of a Regular actor with an Event actor initiates a Create actor process, which transforms its state into the Event actor (Internal). Regular actor's collision with a Connection actor transforms it into an Edge actor state;
a Graph actor subject to a collision transforms into other states the same way as a Regular actor;
Trigger actor after a collision with Event(s) via a Create actor process transforms into Regular actor(s);
Event actor after collision with other actor(s) transforms into the state of Internal event actor(s) or External event actor(s) depending on the logic of the relevant Change state process;
Edge actor after collision with other actor(s) transforms into the state of a Regular actor;
an actor in any of the states—Regular, Event, Trigger or Edge—can transform into a Graph actor if the Change state process will replace its function with another graph.

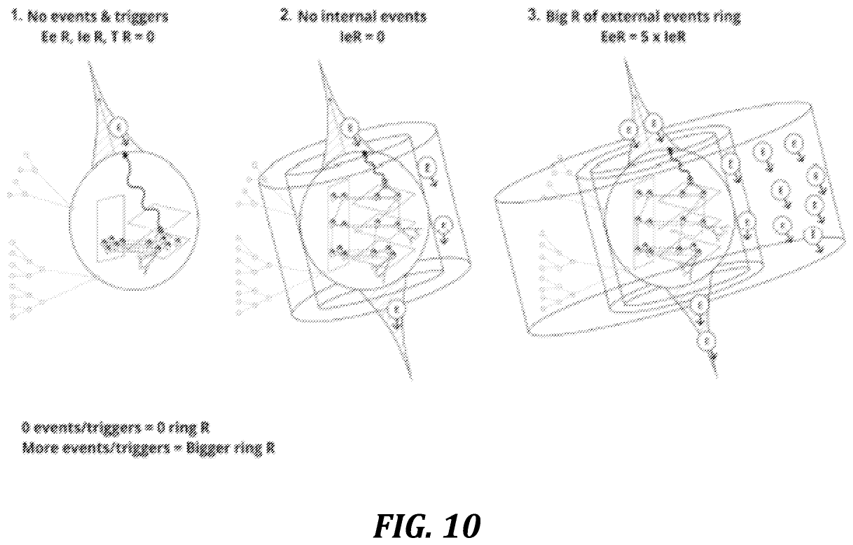

FIG. 10 illustrates a diagram of impact which the trigger rings topology has on the event convection in the actor graph-based model consistent with the present disclosure. Three examples of convection of events demonstrate that the larger radius of the trigger ring means the larger number of events passing through this ring.

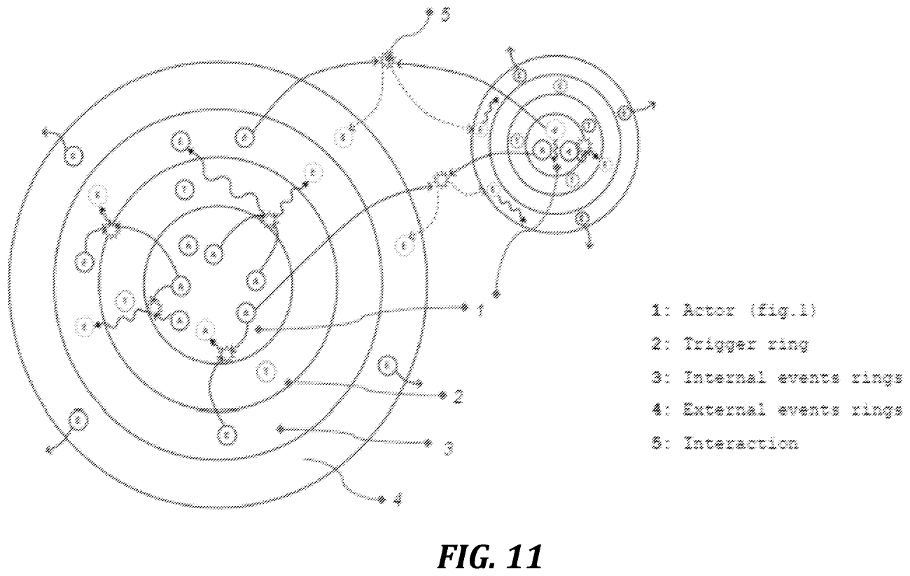

FIG. 11 illustrates a diagram of horizontal convection of events in the actor graph-based model consistent with the present disclosure. The horizontal convection of events may lead to interactions between actors and events which create new events and new actors. The horizontal convection of events includes:
1: Actor (FIG. 2)
2: Triggers ring
3: Internal events rings
4: External events rings
5: Interaction—interaction of an actor and an event initiates two new events

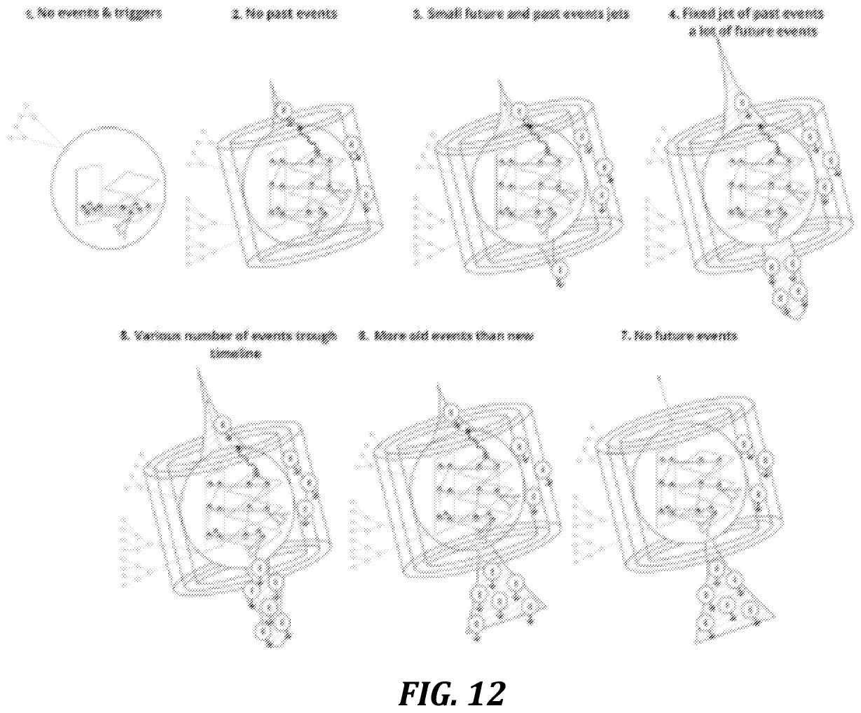

FIG. 12 illustrates a diagram of possible changes in actor event jet topology in the actor graph-based model consistent with the present disclosure. The examples of event jet topology show how the number of future and past events changes the topology of respective event jets.

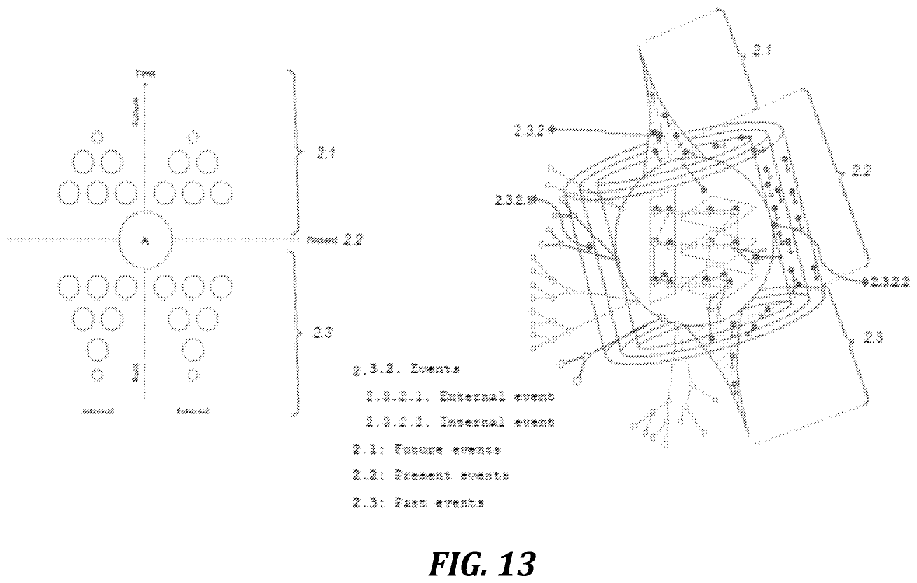

FIG. 13 illustrates a diagram of vertical convection of events in event jets of an actor in the actor graph-based model consistent with the present disclosure.

The jet vertical convection incudes:
2.1: Future events
2.2: Present events
2.3: Past events
2.3.2. Events
2.3.2.1. External event
2.3.2.2. Internal event

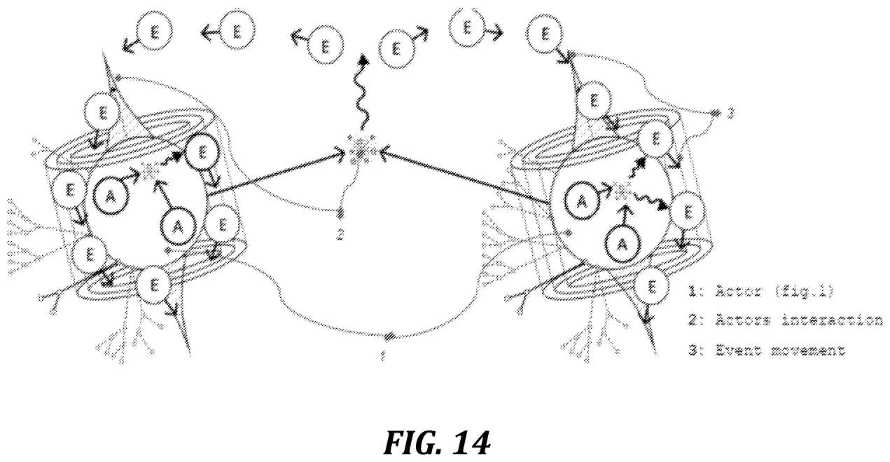

FIG. 14 illustrates a diagram of convection of events created by interaction of actors depicted in FIG. 2 consistent with the present disclosure including:
1: Actor (FIG. 2)
2: Actors interaction (collision)
3: Event movement

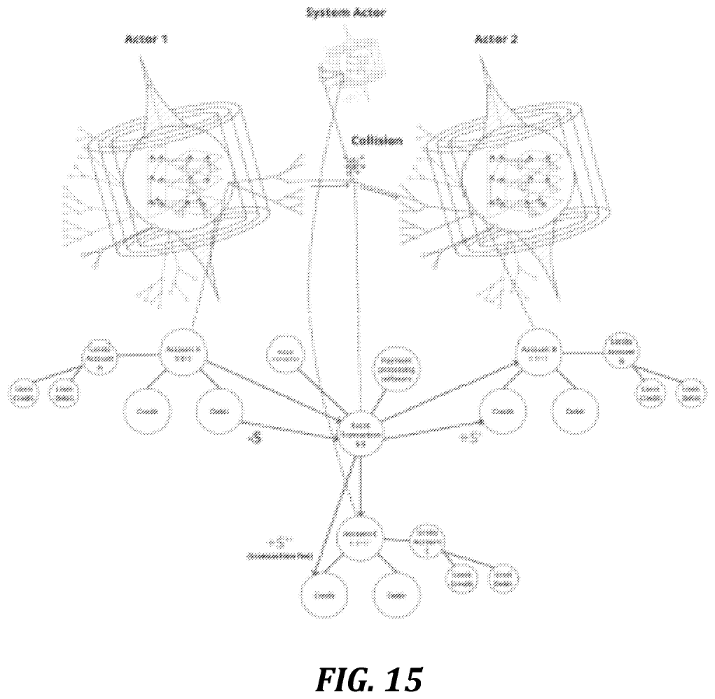

FIG. 15 illustrates how actor interaction is being reflected on actor accounts in the actor graph-based model consistent with the present disclosure. When Actor 1 interacts with Actor 2, their collision creates an event, for example—a transaction of funds transfer in the amount of S dollars from Account A of Actor 1 to Account B of Actor 2. A system actor “Transaction event” is being created and the process embedded in this actor records an operation of “−S” dollars on debit actor of Account A. Then, it splits the amount S into the transferred amount “+S′”, recorded on the credit actor of Account B, and the transaction fee amount “+S″”, recorded on the credit actor of Account C, which belongs to the service provider. Each of accounts A, B, C has also a pair of actors storing the limit values for debit and credit separately. This allows to build business logic based on account limits (thresholds).

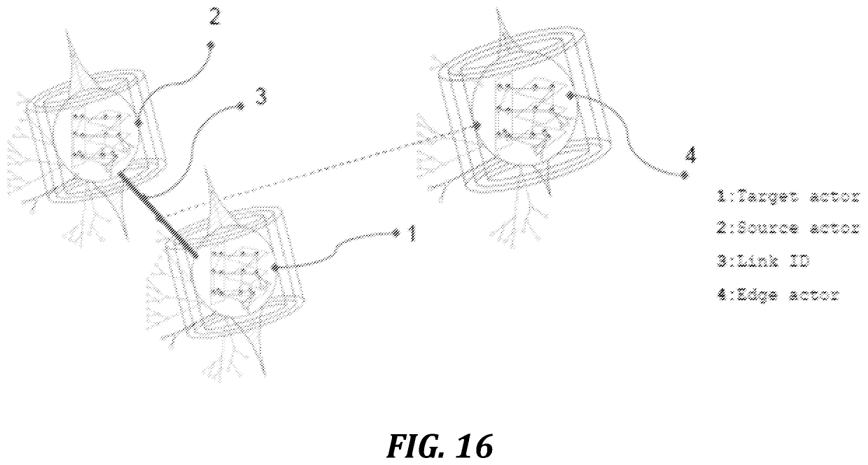

FIG. 16 illustrates graph edges connecting the actors in a graph-based model consistent with the present disclosure. Edges of the graphs here also serve as actors—“edge actors”—and include:
1: Target actor
2: Source actor
3: Link ID
4: Edge Actor

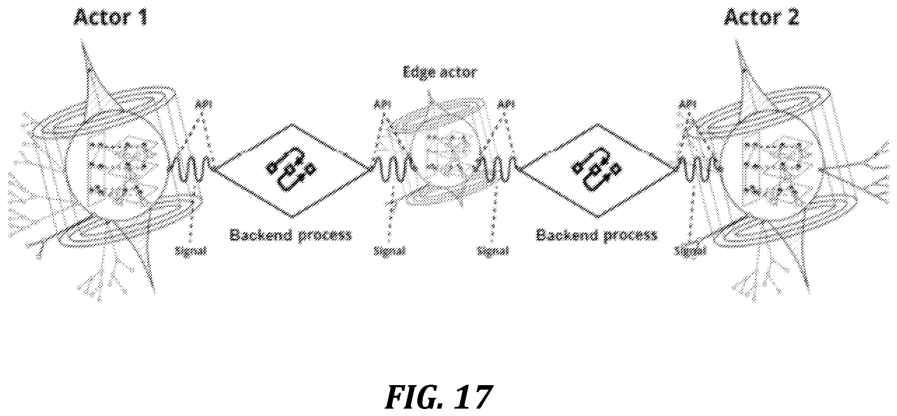

FIG. 17 illustrates how two actors are being connected via an edge actor in a graph-based model consistent with the present disclosure. Actor 1 connects to Actor 2 via an Edge actor. Information signal goes from Actor A via an API interface to a process servicing the connection (“Backend process”), then from the process through another API to the Edge actor. The same connection structure exists between the Edge actor and Actor B.

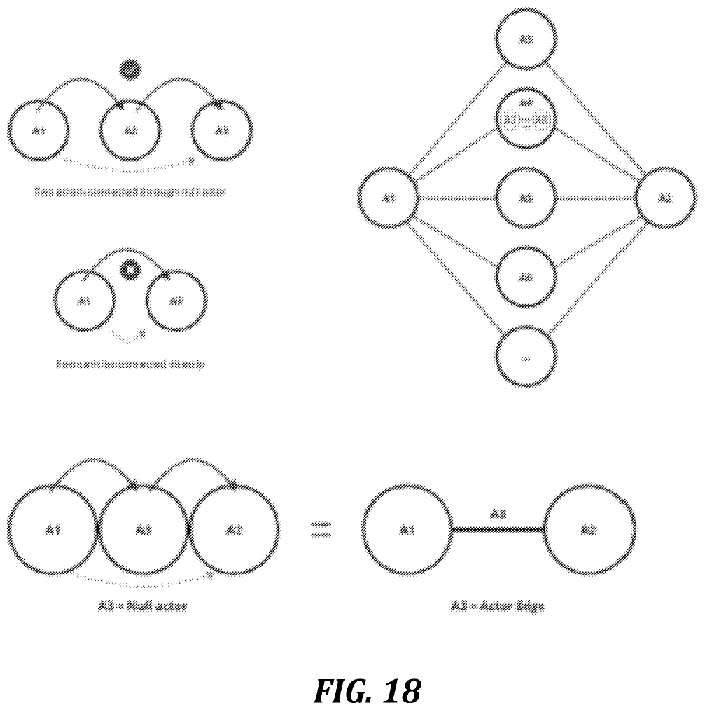

FIG. 18 illustrates the actor connection rules in a graph-based model consistent with the present disclosure. All actors interact through one or more actors. A connection between actors A1 and A2 without additional function (actor edge) is implemented via a Null actor A3. A connection with an additional function is implemented via an Edge actor (A4 . . . . A8).

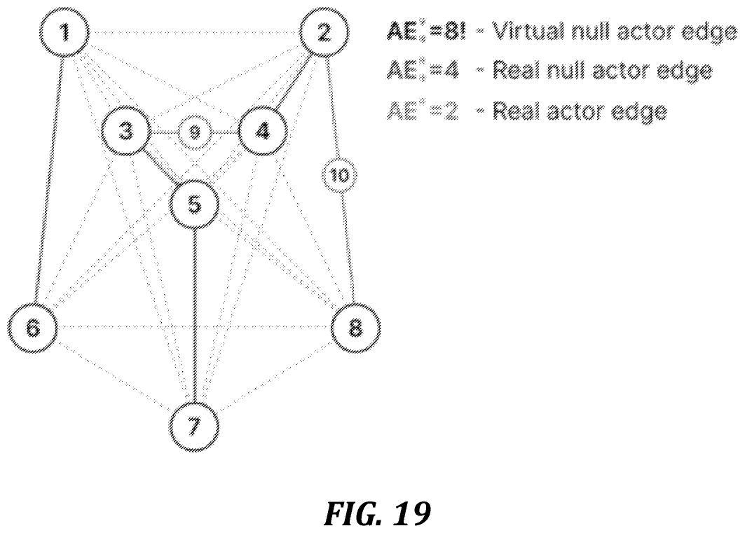

FIG. 19 illustrates the variants of actor edges in the actor graph-based model, consistent with the present disclosure. The example graph consists of eight actors A1 . . . . A8 and has the following types of edges:
Virtual null actor edges-all simple edges without function (null edges) that can potentially be established between any two node actors of the graph. Their total number is AE^{v}₀=n!, where n is the number of node actors (AE^{v}₀=8! in the example in FIG. 19);
Real null actor edges-all null edges really established between actors of the graph. In FIG. 19 their total number is AE^{R}₀=4−edges 1-6, 2-4, 3-5, 5-7;
Real actor edges-all edges with function (Edge actor) attached, really established between actors of the graph. In FIG. 19 their total number is AE^{R}=2−edges 3-9-4 and 2-10-8, where A9 and A10 are Edge actors.

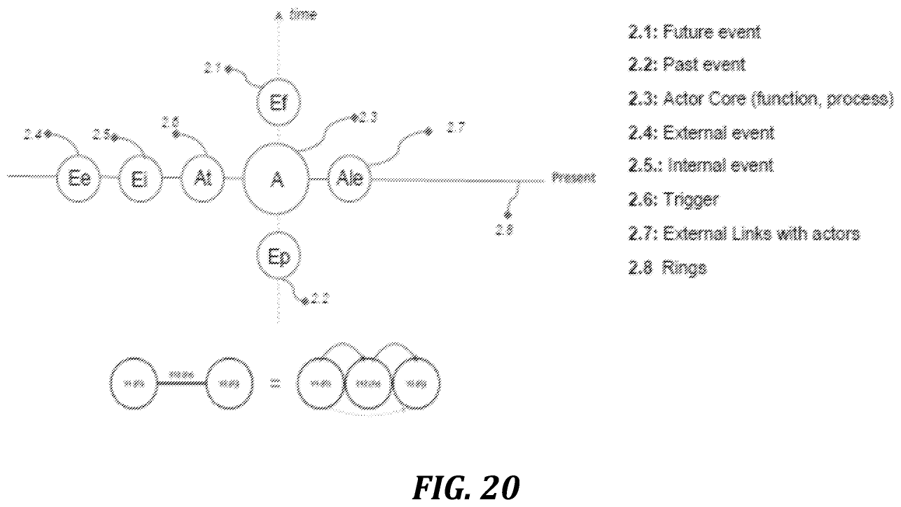

FIG. 20 illustrates a math object “Actor”, which is the abstract summary of an actor as a key element of a graph-based model, consistent with the present disclosure. The math object “Actor” includes:
2.1: Future event
2.2: Past event
2.3: Actor Core (actor function or process)
2.4: Event external
2.5: Event internal
2.6: Trigger
2.7: External Links with actors
2.8: Rings

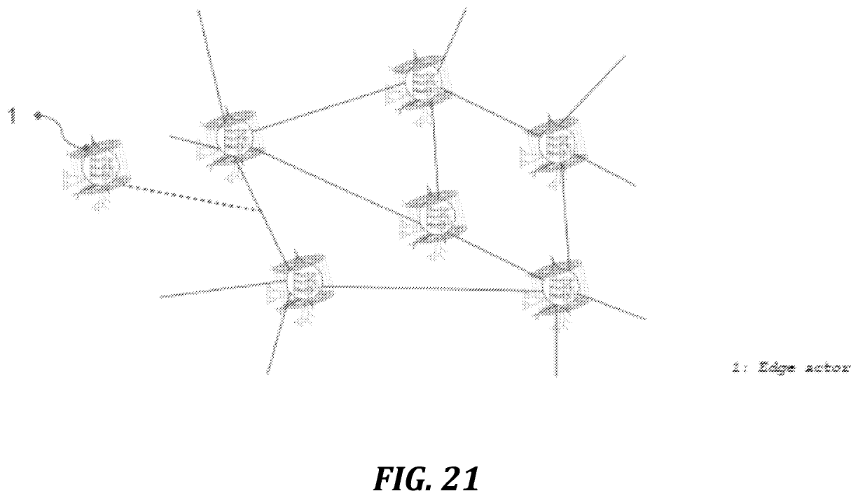

FIG. 21 illustrates an example of the general graph structure of the actor graph-based model consistent with the present disclosure. The actor graph-based model consists of actor nodes connected with edges to form a graph structure. Edges are also actors-“Edge actors” (1).

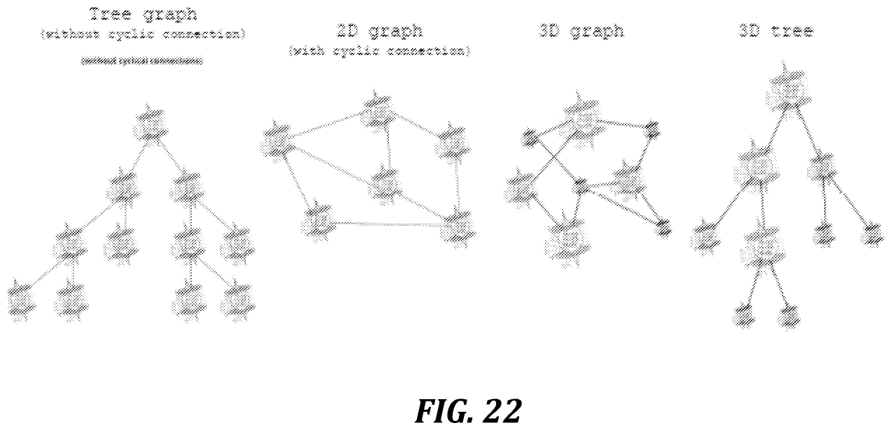

FIG. 22 illustrates examples of different graph types of a graph-based model consistent with the present disclosure, including from left to right: a tree-shaped graph (without cyclic connections), 2D graph (with cyclic connections), 3D graph, and 3D tree.

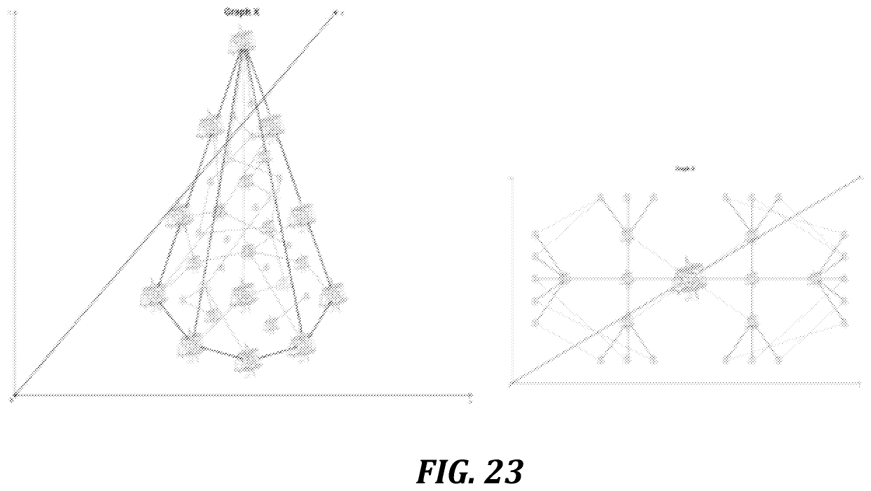

FIG. 23 illustrates an example of a 3D actor graph structure of a graph-based model consistent with the present disclosure. The 3D actor graph is shown in two projections.

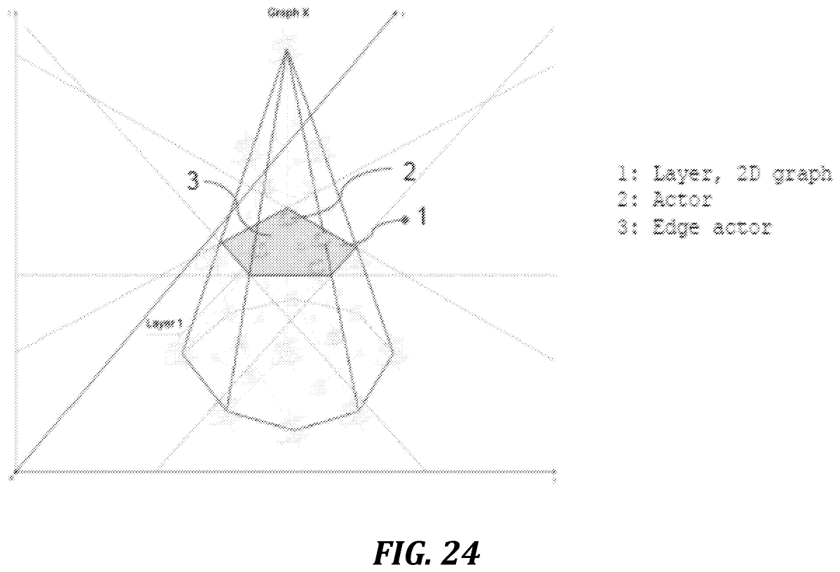

FIG. 24 illustrates an example of a 2D layer in a 3D actor graph X of a graph-based model consistent with the present disclosure. Actor graph layer is a sub-graph which includes a subset of actors of the initial actor graph with their edges, placed on one plane. It could be viewed as a cross-section of an actor graph. In FIG. 24 Layer 1 is a cross section of actor graph X by a plane parallel to the X0Y coordinate plane. Actor graph layer is a 2D graph. The actors on a layer can be pre-selected by the user for convenient display and administration. Actor graph representation as a number of interconnected layers is a convenient tool for building, editing and visualizing the graph layer-by-layer.

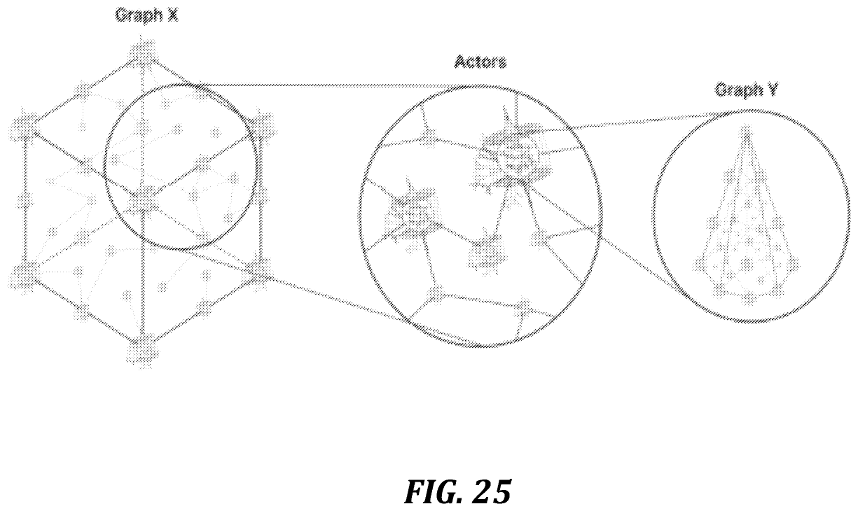

FIG. 25 illustrates a concept of recursion in an actor graph-based model consistent with the present disclosure. Any Regular actor in an actor graph X can be a Graph actor, which comprises another graph—graph Y—as its function (process). There are no limitations on the number of recursion levels.

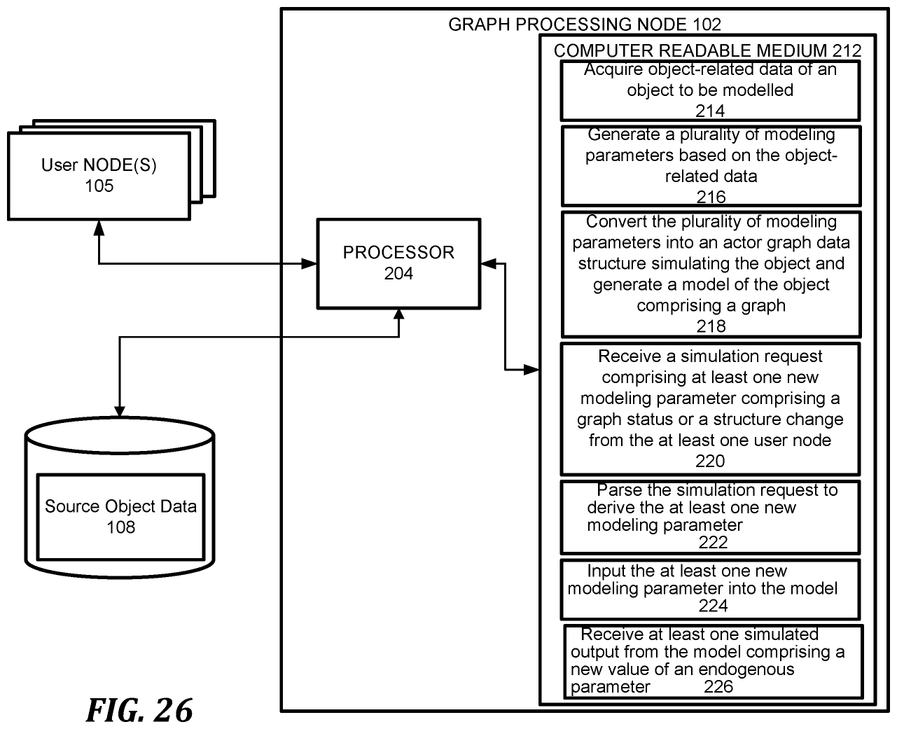

FIG. 26 illustrates a network diagram of a system including detailed features of a graph processing node consistent with the present disclosure.

Referring to FIG. 1, the example network in FIG. 26 includes a graph processing node 102 connected to a user node(s) 105 over a network. The graph processing node 102 is configured to simulate a model of a source object (not shown) associated with one or more user node 105. As discussed above, the graph processing node 102 may acquire source object data directly from the source object including multiple modeling/simulation parameters. The graph processing node 102 may also acquire source object-related static and historic data 108 stored in one or more databases that may be implemented as cloud storages.

As discussed above, the graph processing node 102 may generate the simulated object in the form of an actor graph-based mathematical model based on the source object data and the source object-related static and historic data 108 used for generation of modeling/simulation parameters. Once the simulated object is generated, the user node(s) 105 may send to the graph processing node 102 a request for object status data, a model data change request or a request to simulate a particular hypothesis scenario using the simulated object (i.e., the graph-based mathematical model) based on input parameters included in the request. Then, the graph processing node 102 may implement the requested actions or simulate the requested hypothesis scenario based on the input parameters and may receive a predicted output(s) from the simulated object (i.e., the actor graph-based mathematical model) and may process and provide these outputs to the requester user node 105.

While this example describes in detail only one graph processing node 102, multiple such nodes may be connected to the network of user nodes. It should be understood that the graph processing node 102 may include additional components and that some of the components described herein may be removed and/or modified without departing from a scope of the graph processing node 102 disclosed herein. The graph processing node 102 may be a computing device or a server computer, a cloud server, or the like. As discussed above, the modeling data may be acquired from internal (e.g., from the source object) and external sources (e.g., 108). In one embodiment, the input data may be generated in real-time using archived data or obtained in real time from the object and its live data sources (e.g., on-line data, customer orders, production and sales data, statistical data or dynamically processed data). The simulate object 106′ in a form of the graph-based mathematical model may reside on the graph processing node 102 or it may reside on another server or cloud server.

While this example describes in detail only one graph processing node 102, multiple such nodes may be connected to the network of user nodes. It should be understood that the graph processing node 102 may include additional components and that some of the components described herein may be removed and/or modified without departing from a scope of the graph processing node 102 disclosed herein. The graph processing node 102 may be a computing device or a server computer, a cloud server, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the graph processing node 102 may include multiple processors, multiple cores, or the like, without departing from the scope of the graph processing node 102 system.

The graph processing node 102 may also include a non-transitory computer readable medium 212 that may have stored thereon machine-readable instructions executable by the processor 204. Examples of the machine-readable instructions are shown as 214-226 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire object-related data of an object to be modeled. The processor 204 may fetch, decode, and execute the machine-readable instructions 216 to generate a plurality of modeling parameters based on the object-related data. The processor 204 may fetch, decode, and execute the machine-readable instructions 218 to convert the plurality of modeling parameters into an actor graph data structure simulating the object and generate a model of the object comprising a graph. The processor 204 may fetch, decode, and execute the machine-readable instructions 220 to receive a simulation request comprising at least one new modeling parameter comprising a graph status or a structure change from the at least one user node. The processor 204 may fetch, decode, and execute the machine-readable instructions 222 to parse the simulation request to derive the at least one new modeling parameter. The processor 204 may fetch, decode, and execute the machine-readable instructions 224 to input the at least one new modeling parameter into the model. The processor 204 may fetch, decode, and execute the machine-readable instructions 226 to receive at least one simulated output from the model comprising a new value of an endogenous parameter.

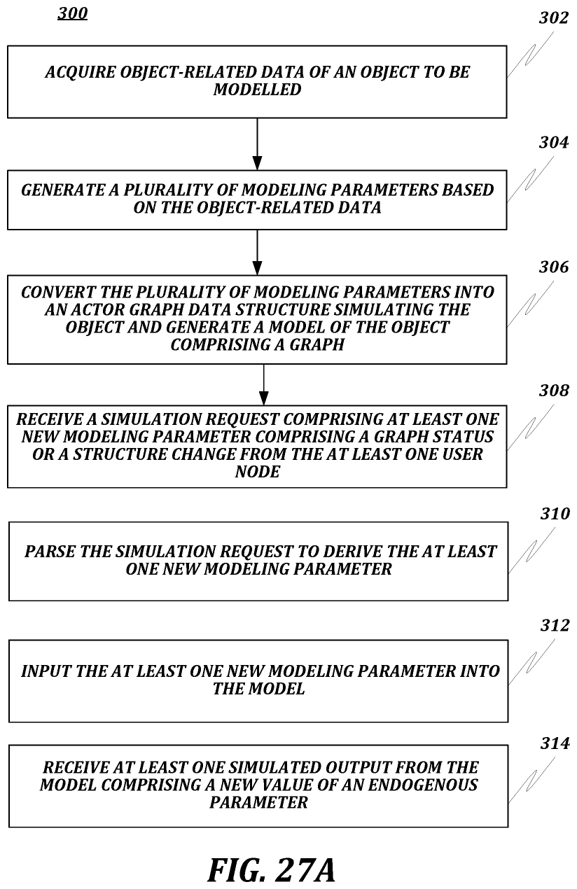

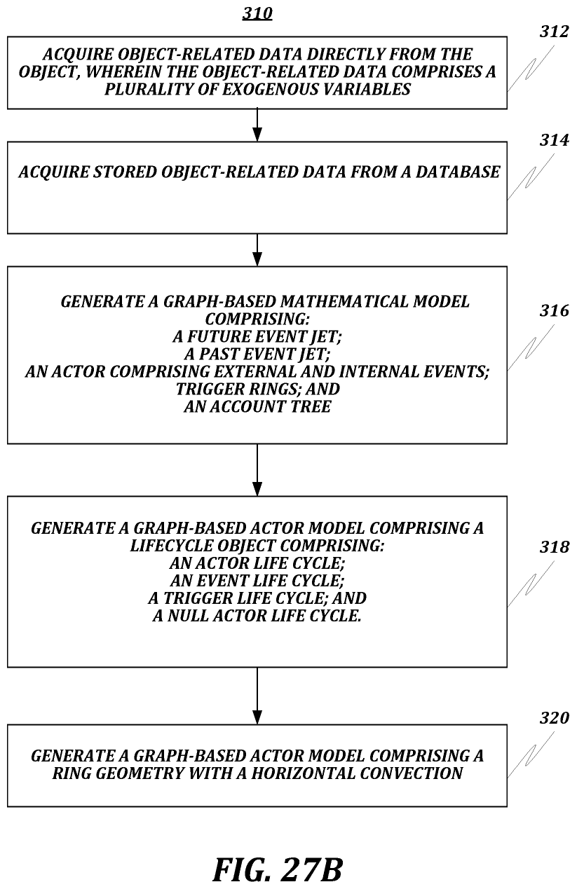

FIG. 27A illustrates a flowchart of a method for an actor graph-based model generation and processing consistent with the present disclosure.

Referring to FIG. 27A, the method 300 may include one or more of the steps described below. FIG. 27A illustrates a flow chart of an example method executed by the graph processing node 102 (see FIG. 26). It should be understood that method 300 depicted in FIG. 27A may include additional operations and that some of the operations described therein may be removed and/or modified without departing from the scope of the method 300. The description of the method 300 is also made with reference to the features depicted in FIG. 26 for purposes of illustration. Particularly, the processor 204 of the graph processing node 102 may execute some or all of the operations included in the method 300.

With reference to FIG. 27A, at block 302, the processor 204 may acquire object-related data of an object to be modeled. At block 304, the processor 204 may generate a plurality of modeling parameters based on the object-related data. At block 306, the processor 204 may simulate the object based on the plurality of modeling parameters to produce a model comprising a graph. At block 308, the processor 204 may receive a simulation request comprising at least one new modeling parameter from the at least one user node. At block 310, the processor 204 may parse the simulation request to derive the at least one new modeling parameter. At block 312, the processor 204 may input the at least one new modeling parameter—i.e., a new value of exogenous parameter or variable, status request or graph structure change request-into the model. At block 314, the processor 204 may receive at least one simulated output from the model—i.e., a new value of endogenous parameter or variable, graph status or structure change.

FIG. 27B illustrates a further flowchart of a method for an actor graph-based model generation and processing consistent with the present disclosure. Referring to FIG. 27B, the method 310 may include one or more of the steps described below. FIG. 27B illustrates a flow chart of an example method executed by the graph processing node 102 (see FIG. 26). It should be understood that method 310 depicted in FIG. 27B may include additional operations and that some of the operations described therein may be removed and/or modified without departing from the scope of the method 310. The description of the method 310 is also made with reference to the features depicted in FIG. 1 for purposes of illustration. Particularly, the processor 204 of the graph processing node 102 may execute some or all of the operations included in the method 310.

With reference to FIG. 27B, at block 312, the processor 204 may acquire object-related data directly from the object, wherein the object-related data comprises a plurality of exogenous variables. At block 314, the processor 204 may acquire stored object-related static and historic data from a database. At block 316, the processor 204 may generate an actor graph-based mathematical model comprising: graph nodes represented by regular actors, event actors and trigger actors; graph edges represented by edge actors; horizontal and vertical actor layers; internal and external events represented by event actors and comprising future event jets and past event jets; trigger rings; actor account trees storing and calculating the exogenous and endogenous variables. At block 318, the processor 204 may generate an actor graph-based model comprising object lifecycles: an actor life cycle; an event life cycle; a trigger life cycle; and a null actor life cycle. At block 320, the processor 204 may generate an actor graph-based model comprising various ring geometries and horizontal and vertical event convections.

The above embodiments of the present disclosure may be implemented in hardware, in a computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

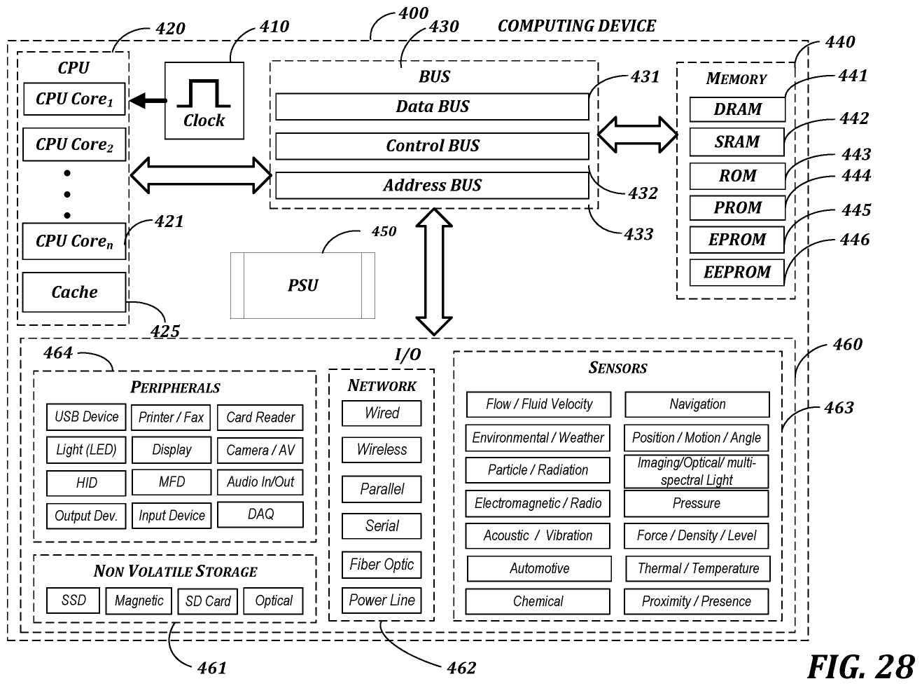

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 28 illustrates an example computing device (e.g., a server node) 400, which may represent or be integrated in any of the above-described components, etc.

FIG. 28 illustrates a block diagram of a system including computing device 400. The computing device 400 may comprise, but not be limited to the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exa-scale supercomputer, a mainframe, or a quantum computer;
A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack mounted, a workstation, an industrial device, a raspberry pi, a desktop, or an embedded device;
The graph processing node 102 (see FIG. 1) may be hosted on a centralized server or on a cloud computing service. Although method 300 has been described to be performed by the graph processing node 102 implemented on a computing device 400, it should be understood that, in some embodiments, different operations may be performed by a plurality of the computing devices 400 in operative communication at least one network.

Embodiments of the present disclosure may comprise a computing device having a central processing unit (CPU) 420, a bus 430, a memory unit 440, a power supply unit (PSU) 450, and one or more Input/Output (I/O) units. The CPU 420 coupled to the memory unit 440 and the plurality of I/O units 460 via the bus 430, all of which are powered by the PSU 450. It should be understood that, in some embodiments, each disclosed unit may actually be a plurality of such units for the purposes of redundancy, high availability, and/or performance. The combination of the presently disclosed units is configured to perform the stages any method disclosed herein.

Consistent with an embodiment of the disclosure, the aforementioned CPU 420, the bus 430, the memory unit 440, a PSU 450, and the plurality of I/O units 460 may be implemented in a computing device, such as computing device 400. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, the memory unit 440, consistent with embodiments of the disclosure.

At least one computing device 400 may be embodied as any of the computing elements illustrated in all of the attached figures, including the graph processing node 102 (FIG. 1). A computing device 400 does not need to be electronic, nor even have a CPU 420, nor bus 430, nor memory unit 440. The definition of the computing device 400 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 28, a system consistent with an embodiment of the disclosure may include a computing device, such as computing device 400. In a basic configuration, computing device 400 may include at least one clock module 410, at least one CPU 420, at least one bus 430, and at least one memory unit 440, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

A system consistent with an embodiment of the disclosure the computing device 400 may include the clock module 410 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 420, the central component of modern computers, which relies on a clock. The only exceptions are asynchronous circuits such as asynchronous CPUs. The clock 410 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 400 use a “clock multiplier” which multiplies a lower frequency external clock to the appropriate clock rate of the CPU 420. This allows the CPU 420 to operate at a much higher frequency than the rest of the computer, which affords performance gains in situations where the CPU 420 does not need to wait on an external factor (like memory 440 or input/output 460). Some embodiments of the clock 410 may include dynamic frequency change, where, the time between clock edges can vary widely from one edge to the next and back again.

A system consistent with an embodiment of the disclosure the computing device 400 may include the CPU unit 420 comprising at least one CPU Core 421. A plurality of CPU cores 421 may comprise identical CPU cores 421, such as, but not limited to, homogeneous multi-core systems. It is also possible for the plurality of CPU cores 421 to comprise different CPU cores 421, such as, but not limited to, heterogeneous multi-core systems, big.LITTLE systems and some AMD accelerated processing units (APU). The CPU unit 420 reads and executes program instructions which may be used across many application domains, for example, but not limited to, general purpose computing, embedded computing, network computing, digital signal processing (DSP), and graphics processing (GPU). The CPU unit 420 may run multiple instructions on separate CPU cores 421 at the same time. The CPU unit 420 may be integrated into at least one of a single integrated circuit die and multiple dies in a single chip package. The single integrated circuit die and multiple dies in a single chip package may contain a plurality of other aspects of the computing device 400, for example, but not limited to, the clock 410, the CPU 420, the bus 430, the memory 440, and I/O 460.

The CPU unit 420 may contain cache 422 such as, but not limited to, a level 1 cache, level 2 cache, level 3 cache or combination thereof. The aforementioned cache 422 may or may not be shared amongst a plurality of CPU cores 421. The cache 422 sharing comprises at least one of message passing and inter-core communication methods may be used for the at least one CPU Core 421 to communicate with the cache 422. The inter-core communication methods may comprise, but not limited to, bus, ring, two-dimensional mesh, and crossbar. The aforementioned CPU unit 420 may employ symmetric multiprocessing (SMP) design.

The plurality of the aforementioned CPU cores 421 may comprise soft microprocessor cores on a single field programmable gate array (FPGA), such as semiconductor intellectual property cores (IP Core). The plurality of CPU cores 421 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the aforementioned computing device 400, and/or the plurality of computing devices 400. The aforementioned communication system will be known to a person having ordinary skill in the art as a bus 430. The bus 430 may embody internal and/or external plurality of hardware and software components, for example, but not limited to a wire, optical fiber, communication protocols, and any physical arrangement that provides the same logical function as a parallel electrical bus. The bus 430 may comprise at least one of, but not limited to a parallel bus, wherein the parallel bus carry data words in parallel on multiple wires, and a serial bus, wherein the serial bus carry data in bit-serial form. The bus 430 may embody a plurality of topologies, for example, but not limited to, a multidrop/electrical parallel topology, a daisy chain topology, and a connected by switched hubs, such as USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper {Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 400 may employ hardware integrated circuits that store information for immediate use in the computing device 400, know to the person having ordinary skill in the art as primary storage or memory 440. The memory 440 operates at high speed, distinguishing it from the non-volatile storage sub-module 461, which may be referred to as secondary or tertiary storage, which provides slow-to-access information but offers higher capacities at lower cost. The contents contained in memory 440, may be transferred to secondary storage via techniques such as, but not limited to, virtual memory and swap. The memory 440 may be associated with addressable semiconductor memory, such as integrated circuits consisting of silicon-based transistors, used for example as primary storage but also other purposes in the computing device 400. The memory 440 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 441, Static Random-Access Memory (SRAM) 442, CPU Cache memory 425, Advanced Random-Access Memory (A-RAM), and other types of primary storage such as Random-Access Memory (RAM).
Non-volatile memory which can retain stored information even after power is removed, for example, but not limited to, Read-Only Memory (ROM) 443, Programmable ROM (PROM) 444, Erasable PROM (EPROM) 445, Electrically Erasable PROM (EEPROM) 446 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 400 may employ the communication system between an information processing system, such as the computing device 400, and the outside world, for example, but not limited to, human, environment, and another computing device 400. The aforementioned communication system will be known to a person having ordinary skill in the art as I/O 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces a plurality of hardware, such as, but not limited to, non-volatile storage 461, communication devices 462, sensors 463, and peripherals 464. The plurality of hardware is used by the at least one of, but not limited to, human, environment, and another computing device 400 to communicate with the present computing device 400. The I/O module 460 may comprise a plurality of forms, for example, but not limited to channel I/O, port mapped I/O, asynchronous I/O, and Direct Memory Access (DMA).
Consistent with the embodiments of the present disclosure, the aforementioned computing device 400 may employ the non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using intermediate area in the memory 440. The non-volatile storage sub-module 461 does not lose data when power is removed and may be two orders of magnitude less costly than storage used in memory module, at the expense of speed and latency. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD)
Molecular Memory
Deoxyribonucleic Acid (DNA) digital data storage

Consistent with the embodiments of the present disclosure, the aforementioned computing device 400 may employ the communication sub-module 462 as a subset of the I/O 460, which may be referred to by a person having ordinary skill in the art as at least one of, but not limited to, computer network, data network, and network. The network allows computing devices 400 to exchange data using connections, which may be known to a person having ordinary skill in the art as data links, between network nodes. The nodes comprise network computer devices 400 that originate, route, and terminate data. The nodes are identified by network addresses and can include a plurality of hosts consistent with the embodiments of a computing device 400. The aforementioned embodiments include, but not limited to personal computers, phones, servers, drones, and networking devices such as, but not limited to, hubs, switches, routers, modems, and firewalls.

Two nodes can be said are networked together, when one computing device 400 is able to exchange information with the other computing device 400, whether or not they have a direct connection with each other. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 462 may comprise a plurality of size, topology, traffic control mechanism and organizational intent. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 400 may employ the sensors sub-module 463 as a subset of the I/O 460. The sensors sub-module 463 comprises at least one of the devices, modules, and subsystems whose purpose is to detect events or changes in its environment and send the information to the computing device 400. Sensors are sensitive to the measured property, are not sensitive to any property not measured, but may be encountered in its application, and do not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake f fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermo-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo-capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ the peripherals sub-module 462 as a subset of the I/O 460. The peripheral sub-module 464 comprises ancillary devices uses to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 400. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 400 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
Data Acquisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 462 sub-module), data storage device (non-volatile storage 461), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system, comprising:
a processor of a graph processing node connected to at least one user node over a network;
a memory on which are stored machine-readable instructions that when executed by the processor, cause the processor to:
acquire object-related data of an object to be modeled;
generate a plurality of modeling parameters based on the object-related data;
convert the plurality of modeling parameters into an actor graph data structure simulating the object and generate a model of the object comprising a graph;
receive a simulation request comprising at least one new modeling parameter comprising a graph status or a structure change from the at least one user node;
parse the simulation request to derive the at least one new modeling parameter;
input the at least one new modeling parameter into the model; and
receive at least one simulated output from the model comprising a new value of an endogenous parameter.

2. The system of claim 1, wherein the instructions further cause the processor to acquire object-related data directly from the object, wherein the object-related data comprises a plurality of exogenous variables.

3. The system of claim 1, wherein the instructions further cause the processor to acquire stored object-related data from a database.

4. The system of claim 1, wherein the instructions further cause the processor to generate an actor graph-based mathematical model comprising:
actor graph comprising graph nodes and edges;
graph nodes comprising actors;
graph edges comprising edge actors;
an actor comprising actor function, external and internal events, a future event jet, a past event jet, trigger rings and an account tree; and
an actor function comprising a process or another actor or another actor graph.

5. The system of claim 4, wherein the graph-based mathematical model comprises an event actor comprising:
event accounts storing: time, posterior probability, prior probability, and location;
an event structure specified by:
an actor;
a file;
a form;
a tag;
a process;
a parent event comprising child event;
a trigger; and
event end time and date.

6. The system of claim 4, wherein the graph-based mathematical model comprises a trigger actor comprising:
a trigger;
processes;
accounts;
a future event jet;
a past event jet;
events ring;
events flow; and
trigger events.

7. The system of claim 1, wherein the instructions further cause the processor to generate an actor graph-based model comprising:
an actor life cycle;
an event life cycle;
a trigger life cycle; and
a null actor life cycle.

8. The system of claim 1, wherein the instructions further cause the processor to generate an actor graph-based model comprising a horizontal and vertical convection of events through trigger rings of trigger actors.

9. A method, comprising:
acquiring, by a graph processing node, object-related data of an object to be modeled;
generating, by the graph processing node, a plurality of modeling parameters based on the object-related data;
converting, by the graph processing node, the plurality of modeling parameters into an actor graph data structure simulating the object and generate a model of the object comprising a graph;
receiving, by the graph processing node, a simulation request comprising at least one new modeling parameter comprising a graph status or a structure change from the at least one user node;
parsing, by the graph processing node, the simulation request to derive the at least one new modeling parameter;
inputting, by the graph processing node, the at least one new modeling parameter into the model; and
receiving, by the graph processing node, at least one simulated output from the model comprising a new value of an endogenous parameter.

10. The method of claim 9, further comprising acquiring object-related data directly from the object, wherein the object-related data comprises a plurality of exogenous variables.

11. The method of claim 9, further comprising acquiring stored object-related data from a database.

12. The method of claim 9, further comprising generating a graph-based mathematical model comprising:
actor graph comprising graph nodes and edges;
graph nodes comprising actors;
graph edges comprising edge actors;
an actor comprising actor function, external and internal events, a future event jet, a past event jet, trigger rings and an account tree; and
an actor function comprising a process or another actor or another actor graph.

13. The method of claim 12, wherein the graph-based mathematical model comprises an event actor comprising:
event accounts storing: time, posterior probability, prior probability, and location;
an event structure specified by:
an actor;
a file;
a form;
a tag;
a process;
a parent event comprising child event;
a trigger; and
event end time and date.

14. The method of claim 12, wherein the graph-based mathematical model comprises a trigger actor comprising:
a trigger;
processes;
accounts;
a future event jet;
a past event jet;
events ring;
events flow; and
trigger events.

15. The method of claim 9, further comprising generating an actor graph-based model comprising:
an actor life cycle;
an event life cycle;
a trigger life cycle; and
a null actor life cycle.

16. The method of claim 9, further comprising generating an actor graph-based model based on a null graph and a plurality of graph layers.

17. A non-transitory computer readable medium comprising instructions, that when read by a processor, cause the processor to perform:
acquiring object-related data of an object to be modeled;
generating a plurality of modeling parameters based on the object-related data;
converting the plurality of modeling parameters into an actor graph data structure simulating the object and generate a model of the object comprising a graph;
receiving a simulation request comprising at least one new modeling parameter comprising a graph status or a structure change from the at least one user node;
parsing the simulation request to derive the at least one new modeling parameter;
inputting, by the graph processing node, the at least one new modeling parameter into the model; and
receiving at least one simulated output from the model comprising a new value of an endogenous parameter.

18. The non-transitory computer readable medium of claim 17, further comprising instructions, that when read by the processor, cause the processor to acquire object-related data directly from the object and from a database, wherein the object-related data comprises a plurality of exogenous variables.

19. The non-transitory computer readable medium of claim 17, further comprising instructions, that when read by the processor, cause the processor to generate a graph-based mathematical model comprising:
actor graph comprising graph nodes and edges;
graph nodes comprising actors;
graph edges comprising edge actors;
an actor comprising actor function, external and internal events, a future event jet, a past event jet, trigger rings and an account tree; and
an actor function comprising a process or another actor or another actor graph.

20. The non-transitory computer readable medium of claim 17, further comprising instructions, that when read by the processor, cause the processor to generate a graph-based mathematical model comprising an event actor comprises:
event accounts storing: time, posterior probability, prior probability, and location; and
an event structure specified by:
an actor;
a file,
a form,
a tag,
a process;
a parent event comprising child event;
a trigger, and
event end time and date.

21. The non-transitory computer readable medium of claim 17, further comprising instructions, that when read by the processor, cause the processor to generate a graph-based mathematical model comprising a trigger actor comprising:
a trigger;
processes;
accounts;
a future event jet;
a past event jet;
events ring;
events flow; and
trigger events.

22. The non-transitory computer readable medium of claim 17, further comprising instructions, that when read by the processor, cause the processor to generate an actor graph-based model comprising:
an actor life cycle;
an event life cycle;
a trigger life cycle; and
a null actor life cycle.

23. The non-transitory computer readable medium of claim 17, further comprising instructions that when read by the processor, cause the processor to generate an actor graph-based model based on a null graph and a plurality of actor graph layers.

24. The non-transitory computer readable medium of claim 17, further comprising instructions, that when read by the processor, cause the processor to generate an actor graph-based model comprising a ring geometry with a horizontal and vertical convection of events.
